(19) United States
(12) Patent Application Publication
(10) Pub. No.: US 2007/0229737 A1
(43) Pub. Date: Oct. 4, 2007

(54) Liquid crystal display apparatus

(75) Inventor: Kazuo Takeda, Hachioji (JP)

Correspondence Address: MILES & STOCKBRIDGE PC, 1751 PINNACLE DRIVE, SUITE 500, MCLEAN, VA, 22102-3833, US

(73) Assignee: Hitachi Displays, Ltd.

(21) Appl. No.: 11/656,479

(22) Filed: Jan. 23, 2007

(30) Foreign Application Priority Data
Mar. 31, 2006 (JP) 2006-096764

(51) Int. Cl. G02F 1/1335

(52) U.S. Cl. 349/117

(57) ABSTRACT

A phase shift element formed on the outer surface of a glass substrate is formed of an organic PAS film, with a refractive index of approximately 1.5. There is atmospheric air (with a refractive index of 1.0) between the phase shift elements. A thickness of the phase shift element is set at 550 nm, a value obtained by substituting 550 nm for a center wavelength and 0.5 for Δn in D1 Δn=center wavelength/2. A phase shift element formed on the inner surface of the glass substrate is an SiN layer (with a refractive index of approximately 2.0). A substance between the phase shift elements is a flattened film which has a heatproof temperature of 600 degrees centigrade or above, a low refractive index, and flattened effect. A thickness of the flattened film may be equal to or larger than a thickness of the phase shift element and thus is set at 550 nm. Through installation of the phase shift elements having a lens effect, light of a back light is efficiently condensed on an aperture part of a pixel, thereby improving the condensation efficiency at the aperture part and increasing an amount of light transmitted through a liquid crystal display panel.

### CLAIM OF PRIORITY

The present application claims priority from Japanese application JP 2006-096764 filed on Mar. 31, 2006, the content of which is hereby incorporated by reference into this application.

### FIELD OF THE INVENTION

The present invention relates to a transmitted light control structure which improves the energy efficiency by improving the light transmittance in a member having a light shielding part and a light transmitting part, and more specifically to a liquid crystal display apparatus realizing higher efficiency and higher luminance by use of a transmitted light control structure capable of achieving lower overall power consumption and higher luminance by increasing the use efficiency of illumination light of a planar shape.

### BACKGROUND OF THE INVENTION

A structure that spatially and temporally controls the in-plane luminance distribution on a transparent substrate for light transmitted through the transparent substrate is useful for achieving higher luminance by improving use efficiency of light exiting through: a pixel aperture in a liquid crystal display apparatus provided with a back light; or a pixel aperture provided in a substrate composing a display apparatus which uses a light emitting element such as an organic EL or the like.

For a liquid crystal display apparatus using a back light, there is a form, as indicated in Japanese Patent No. 3653308, in which light from a light source is transmitted to a light guide plate installed on the back surface of a liquid crystal display panel and then exits in a planar shape from the top surface of the light guide plate. The exiting light is illuminated to the liquid crystal display panel from the rear surface thereof uniformly within the surface by use of an optical compensation member such as a scattering plate, a prism sheet, or the like. On the back surface of the light guide plate, a reflective plate is placed to improve a light utilization ratio. In addition, there is also a well-known form in which a light source is installed immediately below the back surface of a liquid crystal display panel and illumination to the liquid crystal display panel is performed from the rear surface thereof uniformly within the surface by use of an optical compensation member such as a scattering plate or the like.

Due to a growing trend of a display apparatus toward higher definition and also a trend of a transmission type liquid crystal display panel toward a smaller area at an aperture part compared to an area at a non-aperture part such as a thin-film transistor, wires, and the like, the intensity of a back light source needs to be increased while sacrificing the power consumption. That is, higher definition of the liquid crystal display panel involves a problem of an increase in the power consumption. Thus, for a liquid crystal display apparatus using a high-definition liquid crystal panel, technology for improving the transmittance in particular has been becoming more and more important.

Further, for a liquid crystal display apparatus for use in a portable device such as a cellular phone, a small-size information terminal (PDA), or the like, due to need for making an image easily viewable even outdoors, there is a demand for loading a semi-transmission liquid crystal display panel having in a pixel thereof both a transmission type display region and a reflection type display region. With such a semi-transmission liquid crystal display panel, due to light shielding by the reflection region, the utilization ratio of a back light becomes lower for this semi-transmission display panel. Known as one of measures against this phenomenon is the one which condenses illumination light from a back light on a transmission region.

For those using this microlens array, when a normal back light source is used, the position of a diffuser serves as a surface light source and a region where condensation is performed by the microlens is also a surface, thus providing no effect. Thus, as indicated in JP-A No. 189216/2002, measures are taken; for example, an opening is formed in the back light source so that it serves as a point light source array to thereby permit condensation by the microlens. However, also in this case, of the amount of light from the back light, the amount of light entering the liquid crystal display panel is reduced due to the presence of this aperture.

JP-A No. 24050/1999 describes a method of improving substantial transmittance by concentrating light on a pixel aperture part through formation of a phase shift pattern on a different opposite substrate on the illumination light entrance side. In this case, the position where the phase shift pattern is formed is located in a substrate different from a substrate where a thin-film transistor is formed. Thus, the distance between the pixel aperture region and light shielding region is long, and condensation on the pixel aperture cannot be performed if incident light is parallel light. Thus, application of this technology is limited to a display apparatus using a projection-type liquid crystal display panel which permits use of parallel light sources and also which permits a view angle of zero for the liquid crystal display panel.

Moreover, even with a self-luminous display apparatus employing a bottom emission format in which, by use of an organic EL, light emitted therefrom is emanated to the outside from the substrate side, part of light emission from a pixel is shielded by a thin-film transistor, wires, and the like, so that emitted light cannot be emanated sufficiently, thus raising demands for improving the use efficiency of emitted light. The present invention is also applicable to such a self-luminous display apparatus.

### SUMMARY OF THE INVENTION

A liquid crystal display uses, as a display element, a liquid crystal display panel formed by sandwiching a liquid crystal between a pair of transparent substrates. For example, a liquid crystal display panel of a vertical electric field type also referred to as a TN type generates an electric field between a transparent pixel electrode region (pixel region) formed on a first transparent substrate (substrate where a thin-film transistor (TFT) is formed, and hereinafter also referred to as TFT substrate) and a common electrode (opposite electrode) included on another transparent substrate (substrate where a color filter (CF) is formed, and hereinafter also referred to as CF substrate), and controls the orientation of the liquid crystal by this electric field to thereby change the intensity of transmitted light.

However, a region, such as an electrode and wires using metal, through which light is not transmitted, or a region with low transmittance or a region between transparent pixel electrodes which cannot control the orientation of a liquid crystal (these are also referred to as light shielding regions), light is shielded. That is, light of a back light is wasted by the light shielding regions. With past technology, a liquid crystal display panel, which is required to have a large view angle, has difficulty in improving its transmittance without reducing the use efficiency of a back light source.

For a liquid crystal display panel using a polysilicon TFT, a top gate type TFT is typical. In this case, the liquid crystal display panel is structured such that light of a back light directly enters a TFT channel region, thus resulting in drawbacks that light leak current is constantly generated at the TFT when the back light is turned on and that leak current is large even when the TFT is off. To compensate for this large leakage current, voltage application to the liquid crystal is performed under the assistance of a voltage by an electric charge cumulated through the TFT in a large capacitor called an auxiliary capacitance part. This auxiliary capacitance part requires a very large area; therefore, the area of an aperture part becomes small by being compressed by the area of this auxiliary capacitance part, thus resulting in a problem of decreased transmittance.

It is an object of the present invention to provide a high-luminance, high-definition liquid crystal display apparatus by efficiently passing light of a back light through a liquid crystal display panel.

The present invention achieves the object described above by including a phase shift structure in a transparent substrate forming a liquid crystal display panel. In the present invention, the phase shift structure described above composed of an existence pattern of a uniform film thickness is formed with a transparent substance having a refractive index different from that at the periphery thereof by only Δn, and the phase of light passing through a layer of the transparent substance is obtained by shifting the phase of light at the periphery thereof by approximately a half wavelength with respect to a wavelength of 550 nm. At the end of this layer of the transparent substance, a region canceling the light extends in the light traveling direction, and regions intensifying the light extend, on both sides thereof, from the end part at certain angles. Using this characteristic permits formation of a microlens with the phase shift structure.

For example, results of numerical analysis on a light condensing state for a width of 4 micrometer (μm) show that the phase shift structure optimally designed for a wavelength of 550 nm has lens effect over the entire wavelengths from 400 nm to 700 nm. This structure is called “phase shift element”. Forming, on the same transparent substrate where a thin-film transistor is formed (hereinafter also called a glass substrate), this phase shift element in accordance with an aperture part pattern inside a pixel permits efficient light condensation on the aperture part. Moreover; a photolitho process in a TFT formation process can be used for the formation of this phase shift element, thus making it easy to make position adjustment. Further, installation at a close distance in the depth direction from the aperture part through which light is transmitted is possible, so that the permitted limit for the width of distribution of incident light angles for condensing incident light on the aperture part increases, which permits condensation of in-plane light intensity distribution on the aperture part even by use of a back light source having wide incidence angle distribution.

Examples of forming a phase shift element on a TFT substrate include cases where the phase shift element is formed on: one or both of the surface (inner surface) of a glass substrate forming the TFT and the surface (outer surface) thereof, opposite to the inner surface, not forming the TFT; and a layer where metal wires are formed and the outer surface of the glass substrate; and the like. The arrangement of the phase shift element in the surface in the liquid crystal display panel is mainly specified by a black matrix which blocks out a plurality of fluorescent substances. Thus, the end part of the phase shift element is arranged below the black matrix in accordance with this black matrix.

According to the present invention, reducing light entering a TFT part by a phase shift element reduces the amount of light leak in a top gate type TFT and permits a reduction in the area of an auxiliary capacitance part, which in turn permits an improvement in the area of an aperture part.

According to the present invention, the light transmittance of an entire liquid crystal display panel becomes larger than a product of the aperture ratio of the entire liquid crystal display panel and the transmittance of the aperture part, thereby permitting providing a high-luminance, high-definition liquid crystal display apparatus with low power consumption.

Hereinafter, a representative structure of the present invention will be described. A liquid crystal display apparatus according to one aspect of the present invention includes: a liquid crystal display panel having a first transparent substrate, a second transparent substrate so arranged as to oppose the first transparent substrate, and a liquid crystal enclosed between the first transparent substrate and the second transparent substrate; and a back light installed on a back surface of the first transparent substrate of the liquid crystal display panel.

The first transparent substrate of the liquid crystal display panel is provided with a phase shift structure, and an amount of light, of illumination light exiting from the back light, transmitted through the liquid crystal display panel is increased by the phase shift structure.

More specifically, a liquid crystal display panel according to another aspect of the present invention includes a liquid crystal display panel having a first transparent substrate which has a thin-film transistor circuit on an inner surface thereof and a plurality of pixels arranged in a matrix form, a second transparent substrate which has an inner surface thereof so arranged as to oppose the first transparent substrate, and a liquid crystal enclosed between the inner surface of the first transparent and the inner surface of the second transparent substrate; and a back light installed on a back surface of the first transparent substrate of the liquid crystal display panel.

The first transparent substrate of the liquid crystal display panel is provided with a phase shift structure in which a phase shift element is arranged, and an amount of light, of illumination light exiting from the back light, transmitted through the liquid crystal display panel is increased by the phase shift structure.

The phase shift structure is provided on the inner surface of the first transparent substrate, or on the inner surface of the first transparent substrate and an outer surface opposite to the inner surface.

According to another aspect of the present invention, in a liquid crystal display panel using a normal back light source, arranging light distributed to a non-aperture part at an aperture part again improves the light energy efficiency. As a result, the effective transmittance of the liquid crystal display panel improves. Moreover, for a liquid crystal display panel using a top gate type TFT, the area of an auxiliary capacitance part can be reduced, so that the transmittance improves as a result of an increase in the area of the aperture part.

The present invention is applicable to a liquid crystal display apparatus having, on the inner surface of the first transparent substrate, a pixel electrode connected to the thin-film transistor circuit and having an opposite electrode which generates an electric field for controlling orientation of a molecule of the liquid crystal between the opposite electrode and the pixel electrode, applicable to a liquid crystal display apparatus having, on the inner surface of the first transparent substrate, a pixel electrode connected to the thin-film transistor circuit and having, on the inner surface of the second transparent substrate, a common electrode which generates an electric field for controlling orientation of a molecule of the liquid crystal between the common electrode and the picture element electrode, and applicable to other display devices having similar light transmission structures.

### BRIEF DESCRIPTION OF THE DRAWINGS

FIG. 1 is a sectional view describing a first embodiment of a liquid crystal display apparatus according to the present invention;

FIG. 2 is a sectional view describing a second embodiment of the liquid crystal display apparatus according to the present invention;

FIG. 3 is a sectional view describing a third embodiment of the liquid crystal display apparatus according to the present invention;

FIG. 4 is a sectional view describing a fourth embodiment of the liquid crystal display apparatus according to the present invention;

FIG. 5 is a sectional view describing a fifth embodiment of the liquid crystal display apparatus according to the present invention;

FIG. 6 is a sectional view describing a sixth embodiment of the liquid crystal display apparatus according to the present invention;

FIG. 7 is a diagram photographically describing the condition of optical interference at the end part of a phase shift element;

FIG. 8 is a diagram photographically describing effect of light condensation by a phase shift element;

FIG. 9 is a schematic plan view describing an example of arrangement of the phase shift element in a panel; and

FIG. 10 is a development perspective view showing an example of the overall structure of the liquid crystal display apparatus according to the present invention.

### DETAILED DESCRIPTION OF THE PREFERRED EMBODIMENTS

Hereinafter, the preferred embodiments of the present invention will be described in detail with reference to the accompanying drawings. First, general principles of the present invention will be described.

A phase shift element in the present invention is formed of a transparent substance, having a refractive index different from that at the periphery thereof by Δn, in an existence pattern of a uniform film thickness. The phase of light passing through a layer of this transparent substance is obtained by shifting the phase of light at the periphery by approximately a half wave length with respect to a wavelength of 550 nm.

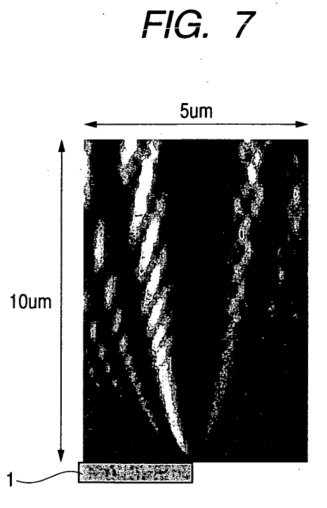

FIG. 7 is a diagram photographically describing condition of optical interference occurring at an end part of the phase shift element. FIG. 7 shows that, at the end part of a layer 1 of the transparent substance described above, a region canceling light extends in the light traveling direction, and on the both sides thereof, regions intensifying the light extend from the end part at certain angles. Using this property permits formation of a microlens with the phase shift element.

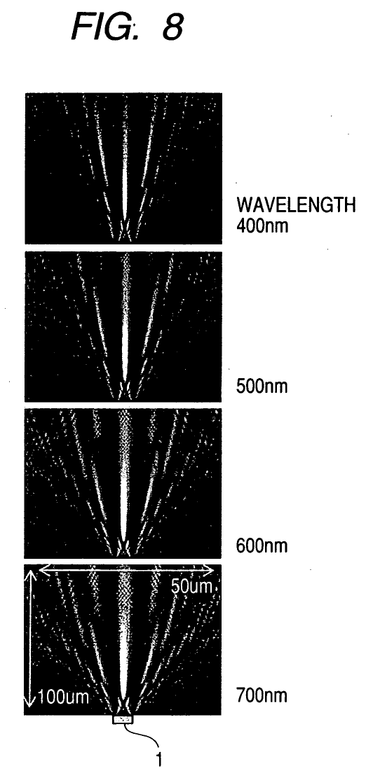

FIG. 8 is a diagram photographically describing effect of light condensation by the phase shift element. Here, results of numerical analysis performed on light condensation state for a width of four micrometer (μm) are shown FIG. 8 proves that the phase shift structure optimally designed for a wavelength of 550 nm has lens effect over all the wavelengths from 400 nm to 700 nm. Formation of this phase shift element, in accordance with a pattern at an aperture part within a pixel, on the same glass substrate where a thin-film transistor is formed permits efficient condensation on this aperture part. FIG. 8 shows the effect of light condensation by the phase shift element for wavelengths of 400 nm, 500 nm, 600 nm, and 700 nm. The displayed sizes are as shown in the figure.

Moreover, a photolitho process in a TFT formation process can be used for the formation of this phase shift element, thus making it easy to make position adjustment with respect to the aperture part. Further, installation at a close distance in the depth direction (substrate thickness direction) from the aperture part through which light is transmitted is possible, so that the permitted limit for the width of incident light angle distribution for condensing the incident light on the aperture part increases, which permits condensation of in-plane light intensity distribution on the aperture part even by use of a back light source having wide incidence angle distribution.

Examples of structure employed for forming such a phase shift element on a TFT substrate include cases where the phase shift element is formed: only on the surface (inner surface) of a glass substrate forming the TFT; on the surface (inner surface) of the glass substrate forming the TFT and the surface (outer surface) thereof not forming the TFT; on a layer on the inner surface of the glass substrate forming the TFT, where metal wires and an electrode are formed, and on the outer surface of the glass substrate; or these in combination.

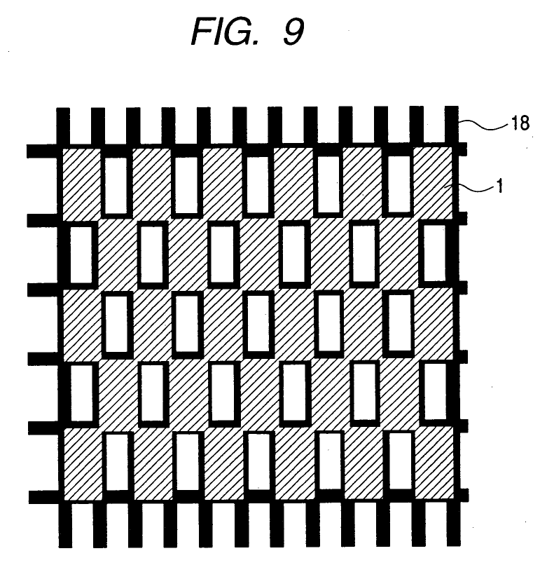

FIG. 9 is a schematic plan view describing an example of arrangement of the phase shift element in the panel. FIG. 9 shows the positional relationship between the phase shift element provided on the TFT substrate and a black matrix provided on a color filter substrate (CF substrate). The same positional relationship applies to a case where the color filter and the black matrix are provided on the TFT substrate side. The arrangement of the phase shift element on the substrate surface in the liquid crystal display panel is specified by the pattern of the black matrix in which non-aperture parts are mainly formed between a plurality of fluorescent substances. Therefore, as shown in FIG. 9, the end part of the phase shift element is arranged below the black matrix in accordance with the pattern.

As described above, reducing light entering the TFT part by the phase shift element decreases the amount of light shielded by the TFT, the wires, or the electrode; which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition.

### First Embodiment

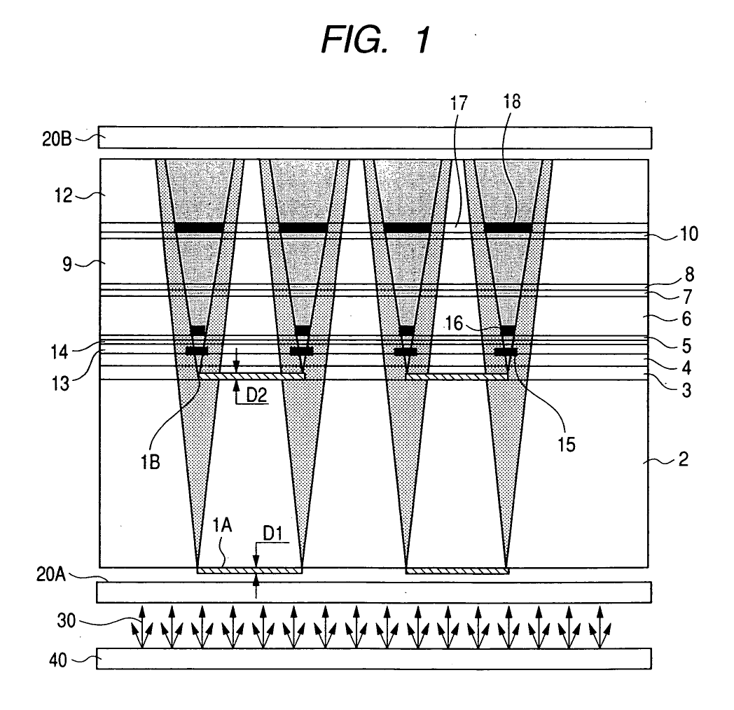

FIG. 1 is a schematic sectional view describing a first embodiment of a liquid crystal display apparatus according to the present invention. This liquid crystal display apparatus is a so-called IPS system (transverse electric field system). In this figure, an arrangement of wires, an electrode, a thin-film transistor, a pixel electrode, an opposite electrode, an insulating layer, and the like is shown in a conceptual diagram. Therefore, the arrangement and structure of these wires, electrode, thin-film transistor, pixel electrode, opposite electrode, insulating layer, and the like are different from actual structure. The same applies to the drawings in the following embodiments.

In FIG. 1, phase shift elements 1A are formed on the outer surface of a glass substrate 2 as a first transparent substrate, and phase shift elements 1B are formed on the inner surface thereof. The phase shift elements 1A and 1B are formed with presence and absence of a pattern array on the surface of the glass substrate 2. The phase shift element 1A on the outer surface is formed of an organic PAS film, with a refractive index of approximately 1.5. There is atmospheric air (with a refractive index of 1.0) between the phase shift elements 1A. A thickness D1 of this element is determined by a formula below. That is, the thickness D1 is set at 550 nm, a value obtained by substituting 550 nm for the center wavelength and 0.5 for Δn in D1 Δn=center wavelength/2.

On the other hand, the phase shift element 1B formed on the inner surface of the glass substrate is an SiN layer (with a refractive index of approximately 2.0). As a substance between the phase shift elements 1B, an application film (SOG flattened film 3) is used which has a heatproof temperature of 600 degrees centigrade or above, a low refractive index, and flattened effect. Examples of a material used for this SOG flattened film 3 include: HSG-R7 (manufactured by Hitachi Chemical Co. Ltd., with a dielectric constant of 2.8 and a heatproof temperature of 650 degrees centigrade), HSG-RZ25 (manufactured by Hitachi Chemical Co. Ltd., with a dielectric constant of 2.5 and a heatproof temperature of 650 degrees centigrade), and the like. Also in the case of the phase shift element 1B, the center wavelength is 550 nm and Δn is approximately 0.5; thus, a thickness D2 is set at 550 nm. The thickness of the SOG flattened film 3 may be equal to or larger than the thickness of the phase shift element and thus is set at 550 nm.

As described above, advantage in providing the phase shift elements 1A on the glass outer surface and the phase shift elements 1B immediately below the TFT in multiple steps lies in that further improvement in the condensation efficiency at the aperture part is achieved. This is the same effect as effect that the focal distance is shortened by providing a lens in multiple steps. Now, the multilayered structure of the TFT substrate will be described. First, formed on the flattened film 3 is a base film 4 for preventing sodium contamination from the glass substrate 2, and formed on this base film 4 is a TFT 10. This TFT has a semiconductor layer of either amorphous silicon or polysilicon. The TFT in the figure also includes an insulating film.

After the formation of the TFT, an insulating layer 13 is formed, on which a transparent electrode is formed and patterned to thereby form an opposite electrode 14. The opposite electrode 14 is covered to form an interlayer insulating film 5 with a thickness of approximately 500 nm. A contact electrode, not shown, to the source and drain of the TFT is formed perpendicularly with the semiconductor layer, and a pixel electrode 7 of an organic PAS layer 6 and the transparent electrode are patterned, on which an oriented film 8 is formed. Further, metal wires 16 are formed which are developed inside the surface. FIG. 1 shows just one example, and wires, electrodes, the insulating layer, and the like involve various processes. Thus, the order, arrangement, and the like of the layers formed in accordance with the processes are different from those shown in FIG. 1.

Formed on a color filter glass substrate 12 as a second transparent substrate are: three types of light filters 17 of R, G, and B, respectively: and a black matrix 18 which blocks out the plurality of light filters, on which an oriented film 10 is formed. In clearance formed between the TFT substrate and the color filter substrate which are opposed to each other, a liquid crystal 9 is enclosed, and the TFT substrate 2 and the color filter substrate 12 are sandwiched with a pair of deflection plates 20A and 20B, respectively, to thereby form a picture display panel. A back light system 40 is composed of a light emitting diode (LED) source and optical compensation members such as a light guide plate, a diffuser, a prism sheet, and the like. Back light beams 30 in this embodiment are not parallel beams of light but have angular distribution of approximately ±30 degrees for the purpose of obtaining the angle of view required for the liquid crystal display panel.

With the first embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing an IPS method.

### Second Embodiment

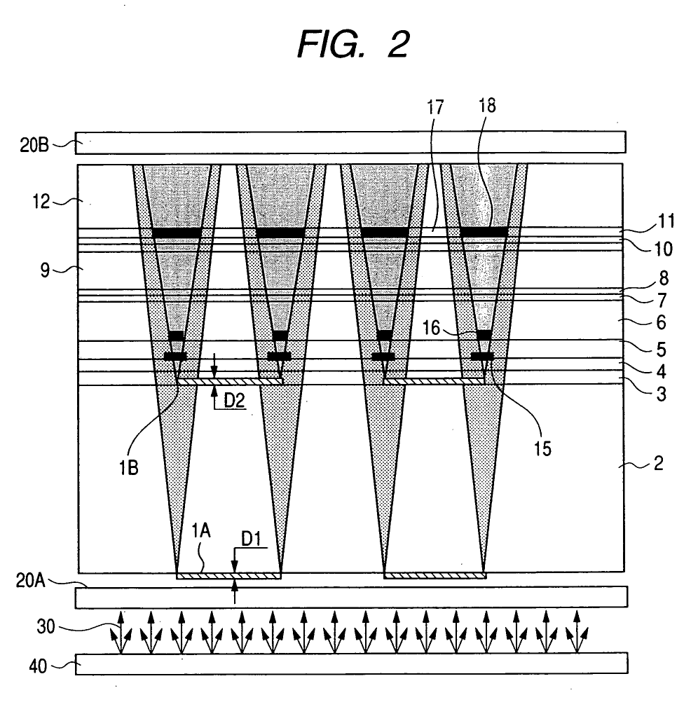

FIG. 2 is a schematic sectional view describing the second embodiment of the liquid crystal display apparatus according to the present invention. This liquid crystal display apparatus employs a so-called TN method (vertical electric field method). On the outer surface and inner surface of a glass substrate 2 as a first transparent substrate forming a thin-film transistor (TFT), phase shift elements 1A and 1B are formed. The phase shift element 1A on the outer surface is formed of an organic PAS film, with a refractive index of approximately 1.5. There is atmospheric air (with a refractive index of 1.0) between the phase shift elements 1A. A thickness D1 of this phase shift element 1A is set at 550 nm, a value obtained by substituting 550 nm for the center wavelength and 0.5 for Δn in D1 Δn=center wavelength/2.

On the other hand, the phase shift element 1B formed on the inner surface of the glass substrate 2 is an SiN layer (with a refractive index of approximately 2.0). As a substance between the phase shift elements 1B, an application film (SOG flattened film 3) is used which has a heatproof temperature of 600 degrees centigrade or above, a low refractive index, and flattened effect. Examples of a material used for this SOG flattened film 3 include: HSG-R7 (manufactured by Hitachi Chemical Co. Ltd., with a dielectric constant of 2.8 and a heatproof temperature of 650 degrees centigrade), HSG-RZ25 (manufactured by Hitachi Chemical Co. Ltd., with a dielectric constant of 2.5 and a heatproof temperature of 650 degrees centigrade), and the like. Also in this case, the center wavelength is 550 nm and Δn is approximately 0.5; thus, a thickness D2 is set at 550 nm. The thickness of the SOG flattened film 3 may be equal to or larger than the thickness of the phase shift element 1B and thus is set at 550 nm. In this manner, advantage in providing the phase shift elements in multiple steps with the phase shift elements 1A on the glass inner surface and the phase shift elements 1B immediately below the TFT of the glass outer surface is the same as is provided in the first embodiment.

Formed on the flattened film 3 of the glass substrate 2 where the phase shift elements 1B are formed is a TFT base film 4 for preventing sodium contamination from the glass substrate 2, and formed on the TFT base film 4 is a TFT 15. This TFT 15 has a semiconductor layer of either amorphous silicon or polysilicon. In the figure, the TFT display also includes an insulating film. After an interlayer insulating film 5 with a thickness of approximately 500 nm is formed following the TFT formation, a contact electrode to the source and drain, not shown, of the TFT is formed perpendicularly with the substrate, and then wires 11 of metal are formed which develop inside the surface. Formed on the wires 11 are an organic PAS layer 6, a pixel electrode 7 as a transparent electrode, and an oriented film 8.

On the other hand, formed on a color filter substrate 12 as a second transparent substrate are: three types of light filters 17 of R, G, and B, respectively; and a black matrix 18, on which an oriented film 10 and a common electrode 11 as a transparent electrode are formed. In clearance between the TFT substrate 2 and the color filter substrate 12, a liquid crystal 9 is enclosed, and the TFT substrate 2 and the color filter substrate 12 are sandwiched with a pair of deflection plates 20A and 20B, respectively, to thereby form a liquid crystal display panel. A back light system 40 is composed of a light emitting diode (LED) source and optical compensation members such as a light guide plate, a diffuser, a prism sheet, and the like. Back light beams 30 in this embodiment are not parallel beams of light but have angular distribution of approximately ±30 degrees for the purpose of obtaining the angle of view required for the liquid crystal display panel.

With the second embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing a TN method.

### Third Embodiment

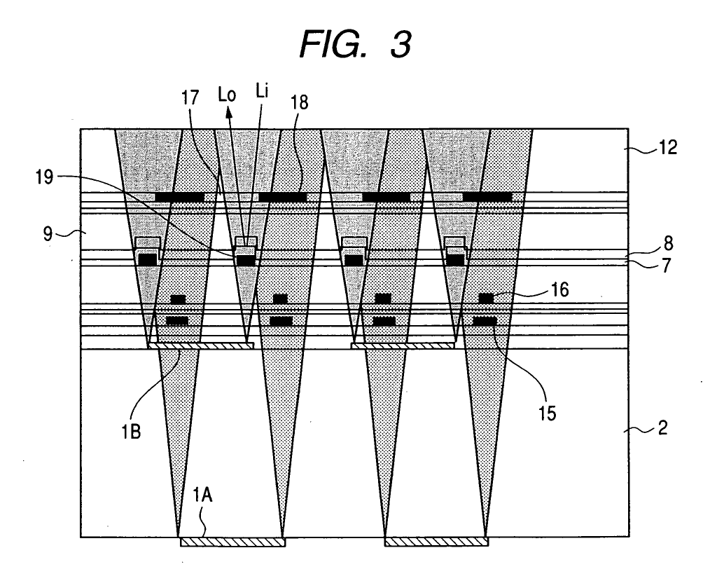

FIG. 3 is a sectional view describing the third embodiment of the liquid crystal display apparatus according to the present invention. The third embodiment is applied to a liquid crystal display panel of a semi-transmission liquid crystal display apparatus employing a TN method. In FIG. 3, for simplification, deflection plates 20A and 20B, and a back light system 40 are omitted from the illustration. In FIG. 3, this liquid crystal display is structured such that, in addition to illumination light from the back light system, external light Li entering from the color filter substrate 12 side passes through a color filter 17 and then through the layer of a liquid crystal 9, is reflected on a reflective plate 19, passes again through the layer of the liquid crystal 9 and then through the color filter 17, and exits to the outside as outgoing light Lo. In this case, the passage through the liquid crystal layer 9 twice requires that the thickness of the liquid crystal layer 9 at the reflective plate region is half the thickness thereof at the transmission part. Thus, an oriented film 8 and a pixel electrode 7 at the reflective plate region are located high, and thus this portion is formed into a step-like shape. This reflective plate region is a non-aperture region where illumination light from the back light is shielded; thus, phase shift elements 1A and 1B are installed with respect to this reflective plate region so that light is shielded. In FIG. 3, the phase shift element 1A formed on the outer surface of the TFT glass substrate 2 is associated with a black matrix 18, and the phase shift element 1B formed below the TFT 15 is associated with the reflective plate region, but vise versa is also permitted.

With the third embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing a semi-transmission method.

### Fourth Embodiment

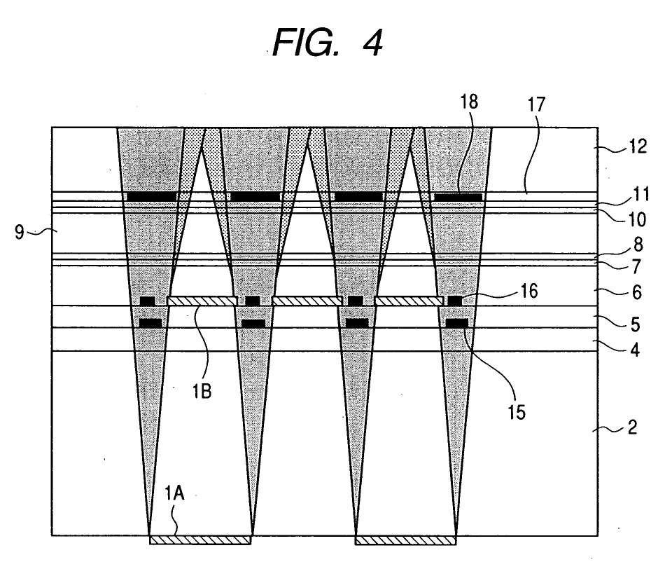

FIG. 4 is a sectional view describing the fourth embodiment of the liquid crystal display apparatus according to the present invention. In the fourth embodiment, the present invention is applied to a liquid crystal display apparatus employing a TN method. In FIG. 4, for simplification, deflection plates 20A and 20B, and a back light system 40 are omitted from the illustration. In FIG. 4, the same reference numerals as those in FIG. 2 correspond to the same functional portions and only portions specific to this embodiment will be described. In the fourth embodiment, phase shift elements 1B of an SiN film having a refractive index of approximately 2.0 in an organic layer PAS 6 with a refractive index of approximately 1.5 formed on the inner surface of a TFT glass substrate 2, and phase shift elements 1A on the outer surface of the glass substrate 2 are formed in multiple steps. In this case, since no phase shift element is formed below a TFT15, there is no need for forming, between the TFT 15 and the glass substrate 2, an interlayer film of SOG as employed in the embodiment described above.

With the fourth embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing a semi-transmission method.

### Fifth Embodiment

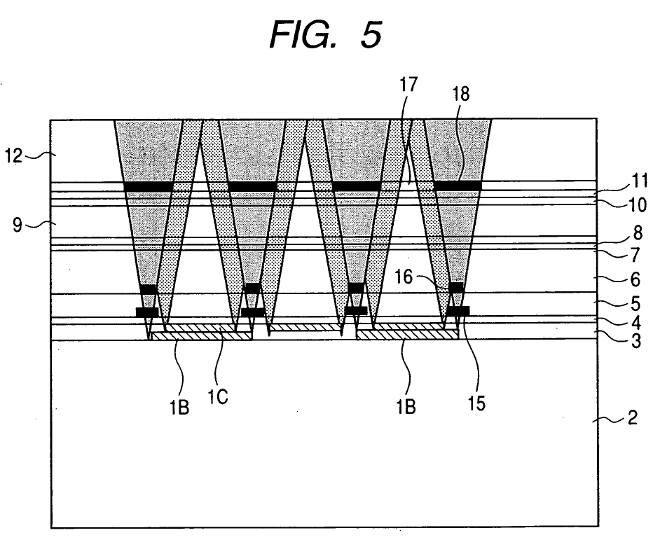

FIG. 5 is a sectional view describing the fifth embodiment of the liquid crystal display apparatus according to the present invention. Also in the fifth embodiment, the present invention is applied to a liquid crystal display apparatus employing a TN method. In FIG. 5, same reference numerals as those in FIG. 2 correspond to the same functional portions and only portions specific to this embodiment will be described. In FIG. 5, for simplification, deflection plates 20A and 20B, and a back light system 40 are omitted from the illustration. In the fifth embodiment, phase shift elements 1B and 1C are formed in multiple steps in a flattened layer 3 of SOG on the inner surface of the glass substrate 2.

One advantage in providing the multiple-step structure of the phase shift elements 1B and 1C in this embodiment lies in that position adjustment is easier than that in the second embodiment since the 1B and 1C in the multiple steps are formed in a patterning process only on the same inner surface of the TFT glass substrate 2. One advantage of the multiple-step structure as is the case with the second embodiment lies in that efficiency in condensation to the aperture part at close distance improves due to shorter focal distance of the phase shift elements. In this structure, it is required that, as viewed from a light source, the width of the downstream phase shift element (phase shift element 1C in FIG. 5) is smaller than the width of the upstream phase shift element (phase shift element 1B in FIG. 5). Continuously changing the element width of the phase shift elements forms a lens. For a lens, it is difficult to form a curved surface by a photolitho process. In the fifth embodiment 5, a curved surface can be formed by the photolitho process through digitization, and distribution of in-plane light intensity inside the liquid crystal display panel is controlled.

With the fifth embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing a semi-transmission method.

### Sixth Embodiment

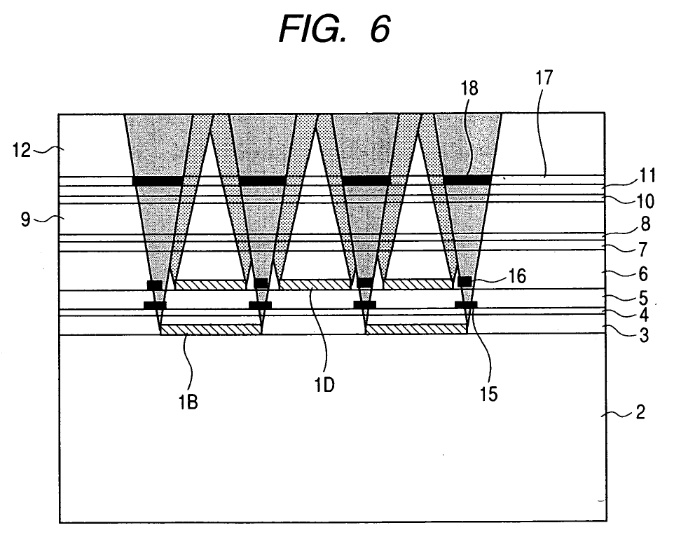

FIG. 6 is a sectional view describing the sixth embodiment of the liquid crystal display apparatus according to the present invention. Also in the sixth embodiment, the present invention is applied to a liquid crystal display apparatus employing a TN method. In FIG. 6, same reference numerals as those in FIG. 2 correspond to the same functional portions and only portions specific to this embodiment will be described. In the sixth embodiment, phase shifts elements are formed in multiple steps including: phase shift elements 1D formed of an SiN film having a refractive index of approximately 2.0 in an organic layer PAS 6 with a refractive index of approximately 1.5 formed on the inner surface of a TFT glass substrate 2; and phase shift elements 1B formed immediately below a TFT.

One advantage in providing the multiple-step structure in this embodiment lies in that position adjustment is easier than that in the second embodiment since this involves a patterning process only on the same inner surface of the TFT glass substrate 2. The same advantage of the multiple-step structure as that in the second embodiment lies in that efficiency in condensation to the aperture part at close distance improves due to a shorter focal distance of the phase shift elements. In the structure of this embodiment, it is required that, as viewed from a light source, the width of the downstream phase shift element (phase shift element 1D in FIG. 6) is smaller than the width of the upstream phase shift element (phase shift element 1B in FIG. 6). As is the case with the fifth embodiment, continuously changing the element width of the phase shift elements forms a lens. For a lens, it is difficult to form a curved surface by a photolitho process. In the fifth embodiment 6, however, a curved surface can be formed by the photolitho process through digitization, and distribution of in-plane light intensity inside the liquid crystal display panel is controlled.

With the sixth embodiment, reducing light entering the TFT part by the phase shift element decreases the amount of light shielded by the TFT, the wires, or the electrode, which permits an improvement in the pixel aperture ratio and reduction in the area of the auxiliary capacitance part accordingly, thus resulting in an increase in the amount of light transmitted through the entire liquid crystal display panel to thereby achieve higher luminance and higher definition in the liquid crystal display employing a semi-transmission method.

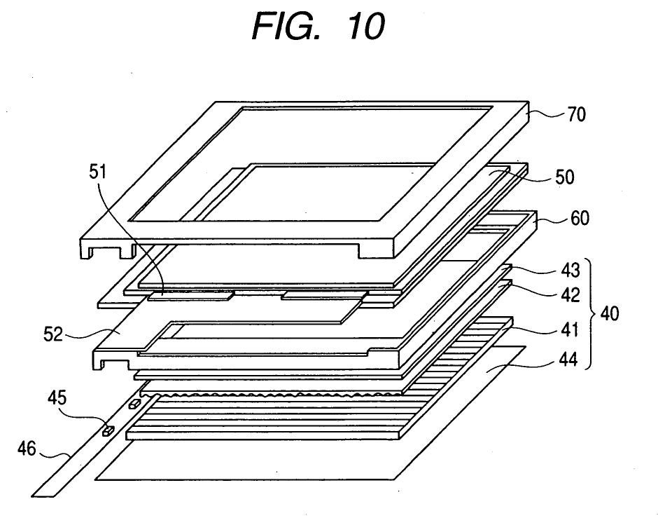

FIG. 10 is a development perspective view showing an example of the overall structure of the liquid crystal display apparatus according to the present invention. In FIG. 10, a liquid crystal display panel 50 has the phase shift structure of any of the embodiments descried above, and is formed by sandwiching a liquid crystal layer with a pair of glass substrates having image forming elements such as an electrode, a color filter, and the like for pixel selection formed on one or both primary surfaces (inner surfaces). On one of this pair of glass substrates, a drive circuit chip (IC chip) 51 is arranged which controls driving for display on the liquid crystal display panel 50.

The liquid crystal display panel 50 is sandwiched by a top frame 70 usually formed of a metal frame and a mold 60 usually formed of resin from the top and the bottom, respectively, as viewed in FIG. 10. Below the mold 60 (back surface), a back light system 40 is installed which is composed of: a prism sheet 42, a light guide plate 41, at least one (here, four) light emitting diode element 45 arranged on a side surface of the light guide plate 41 and forming a light source; and a reflective sheet 44 installed at the bottom side of the light guide plate 41.

To the drive circuit tip 51, display data, a timing signal, power, and the like are supplied from an external circuit (information processor), not shown, through the print circuit 52. Moreover, the light emitting diode element 45 is loaded in a light source flexible printed circuit 46 in such a manner as to be installed near or in close contact with the light entrance surface of the light guide plate 41.

In this liquid crystal display apparatus, the prism sheet 42 is a downward prism sheet having prism grooves on the bottom surface thereof. The light guide plate 41 has, on the top surface thereof, a large number of grooves each circular-arc shaped in cross section and, on the bottom surface thereof, a large number of grooves each a triangular shaped in cross section and extending in the direction orthogonal to the grooves circular-arc shaped in cross section. Furthermore, the light emitting diode element 45 is so installed as to face the light entrance surface of the light guide plate 41. A liquid crystal display apparatus to which the present invention is applied is not limited to the one having the structure shown in FIG. 10. Thus, the present invention is also applicable in the same manner to liquid crystal display apparatuses having other well-known structures.

The present invention is not limited to the structure of the embodiments described above, and also applicable to these embodiments in combination, applicable in combination with a liquid crystal display apparatus employing an IPS method, a TN method, or another method, or applicable to another display element of a similar type such as an organic EL display apparatus or the like.

What is claimed is:

1. A liquid crystal display apparatus, comprising:
a liquid crystal display panel having a first transparent substrate, a second transparent substrate so arranged as to oppose the first transparent substrate, and a liquid crystal enclosed between the first transparent substrate and the second transparent substrate; and
a back light installed on a back surface of the first transparent substrate of the liquid crystal display panel,
wherein the first transparent substrate of the liquid crystal display panel is provided with a phase shift structure, and
an amount of light, of illumination light exiting from the back light, transmitted through the liquid crystal display panel is increased by the phase shift structure.

2. The liquid crystal display apparatus according to claim 1, wherein the phase shift structure is provided on an inner surface of the first transparent substrate.

3. The liquid crystal display apparatus according to claim 1, wherein the phase shift structure is provided on the inner surface of the first transparent substrate and on an outer surface opposite to the inner surface.

4. A liquid crystal display apparatus, comprising:
a liquid crystal display panel having a first transparent substrate which has a thin-film transistor circuit on an inner surface thereof and a plurality of pixels arranged in a matrix form, a second transparent substrate which has an inner surface thereof so arranged as to oppose the first transparent substrate, and a liquid crystal enclosed between the inner surface of the first transparent and the inner surface of the second transparent substrate; and
a back light installed on a back surface of the first transparent substrate of the liquid crystal display panel,
wherein the first transparent substrate of the liquid crystal display panel is provided with a phase shift structure, and
an amount of light, of illumination light exiting from the back light, transmitted through the liquid crystal display panel is increased by the phase shift structure.

5. The liquid crystal display apparatus according to claim 2, wherein the phase shift structure is provided on the inner surface of the first transparent substrate.

6. The liquid crystal display apparatus according to claim 2, wherein the phase shift structure is provided on the inner surface of the first transparent substrate and on an outer surface opposite to the inner surface.

7. The liquid crystal display apparatus according to claim 4, wherein transmittance of the entire liquid crystal display panel is larger than a product of an aperture ratio of the entire liquid crystal display panel and transmittance of an aperture part.

8. The liquid crystal display apparatus according to claim 7, having, on the inner surface of the first transparent substrate, a pixel electrode connected to the thin-film transistor circuit and having an opposite electrode which generates an electric field for controlling orientation of a molecule of the liquid crystal between the opposite electrode and the pixel electrode.

9. The liquid crystal display apparatus according to claim 7, having, on the inner surface of the first transparent substrate, a pixel electrode connected to the thin-film transistor circuit and having, on the inner surface of the second transparent substrate, a common electrode which generates an electric field for controlling orientation of a molecule of the liquid crystal between the common electrode and the picture element electrode.

10. The liquid crystal display apparatus according to claim 4, having, on the inner surface of the first transparent substrate, a black matrix which blocks out a color filter of a plurality of colors and the color filter.

11. The liquid crystal display apparatus according to claim 4, having, on the inner surface of the second transparent substrate, a black matrix which blocks out a color filter of a plurality of colors and the color filter.
